(19) United States
(12) Patent Application Publication
(10) Pub. No.: US 2010/0286017 A1
(43) Pub. Date: Nov. 11, 2010

(54) Stain Treating Composition

(75) Inventor: Zefferino Righetto, Ladenburg (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/680,837

(22) PCT Filed: Sep. 15, 2008
(86) PCT No.: PCT/GB08/03134

§ 371 Date: Jul. 12, 2010

(30) Foreign Application Priority Data
Oct. 2, 2007 (GB) 0719181.0

(51) Int. Cl. B67D 7/74; C11D 3/386

(52) U.S. Cl. 510/283; 222/145.1

(57) ABSTRACT

A two-compartment dispenser comprises a first compartment, a second compartment and dispensing means. The first compartment contains an aqueous composition comprising a source of active oxygen and having a pH of greater than 0 but less than 7 and a perhydrolase enzyme. The second compartment contains an aqueous composition comprising an ester. The dispensing means is adapted to dispense the contents (or part thereof) of the compartments on to a surface either sequentially or simultaneously to form a mixture thereof.

This invention relates to an improved process for the removal of stains from surfaces, preferably from fabric, and to compositions used in such processes.

The use of oxygen bleaches with or without enzymes in compositions for stain removal has been known for a long time and many such compositions are available. However a common difficulty in formulating such a composition is to ensure that the bleach remains stable during storage but is sufficiently active on use. This is particularly difficult to achieve in liquid compositions.

One solution has been to formulate liquid peroxygen bleaches at pHs between about 3 and 7 to produce a stable composition, but such compositions do not provide sufficient bleaching power to be useful for many household situations. Attempts have therefore also been made to formulate liquid peroxygen bleach compositions at pHs above this range to improve their performance. However these generally require expensive stabilising compounds to prevent loss of activity after manufacture.

The present invention provides a peroxide bleach product which has acceptable stability of the peroxide during storage, but which is capable of providing effective stain removal power when used by the consumer.

WO 9731095 describes an apparatus for claiming surfaces that contains two liquids that are mixed upon delivery to the surface. The first liquid contains a hydrohalite bleach. The second liquid has a chelating agent or a builder. The pH on mixture of the two liquids is about 11.

We have found that providing two separate compositions that are mixed during, before or after (preferably during or before) application have excellent stability and performance.

Enzymes are a common component of stain treating compositions. Enzymes lose their cleaning performance in presence of a strong oxidant, such as hydrogen peroxide at alkaline pH. Surprisingly, we have found that by the inclusion of a surfactant or a water-soluble polymer in either or both of the separate compositions, (preferably present in at least the enzyme composition or both compositions) excellent cleaning performance is achieved. Whilst not wishing to be bound by theory, it is believed that the activity of the enzyme is maintained for a longer period after the peroxide composition is mixed with the enzyme composition by the protective effects of surfactant micelles formed in the mixture.

According to the invention there is provided a multi-compartment dispenser comprising

a first compartment containing an aqueous composition comprising a source of active oxygen and having a pH of greater than 0 but less than 7 and a perhydrolase enzyme;

a second compartment containing an aqueous composition comprising an ester; and

dispensing means adapted to dispense the contents (or part thereof) of the compartments on to a surface either sequentially or simultaneously to form a mixture thereof.

We have found that the dispenser according to the present invention provides advantageous properties, particularly when used in a cleaning process. These advantages include improved cleaning performance on bleachable stains and enhanced bactericidal activity. Without wishing to be bound by theory these affects are attributed to the formation of a peracid from the reaction of the peroxide, ester and enzyme.

Generally the ester is present in an amount of 0.01 to 50 wt %, most preferably from 5-10 wt %.

Preferably the ester is selected from the group comprising methyl lactate, ethyl lactate, methyl glycolate, ethyl glycolate, methyl methoxyacetate, ethyl methoxyacetate, methyl 3-hydroxybutyrate, ethyl 3-hydroxybutyrate, ethyl methoxyacetate, ethylene glycol diacetate, propylene glycol diacetate, butyl acetate, isoamyl acetate, hexyl acetate, octyl acetate, linalyl acetate, citronellyl acetate, dodecyl acetate, neodol 233 acetate, neodol 236.5 acetate, neodol 239 acetate, ethyl propionate, butyl propionate, hexyl propionate, citronellyl propionate, ethyl butyrate, ethyl isobutyrate, ethyl 2-methylbutyrate, ethyl isovalerate, tributyrin, tri-caproin, tricaprylin, dimethyl malonate, diethyl maleate and mixtures thereof.

The ester may be a glyceride selected from the group comprising monoacetin, diacetin, triacetin, monobutyrin, dibutyrin, tributyrin, glyceryl monooctanoate, glyceryl dioctanoate, glyceryl trioctanoate, and mixtures thereof

The ester may be a long chain acyl ester selected from the group comprising caproic acid ester, caprylic acid ester, nonanoic acid ester, decanoic acid ester, dodecanoic acid ester, myristic acid ester, palmitic acid ester, stearic acid ester, and oleic acid ester.

Preferably a compartment comprises at least one surfactant or water-soluble polymer and are mixed not more than two hours before being applied to the surface requiring stain removal.

Preferably the second compartment contains at least one other enzyme.

### Sources of Active Oxygen

An essential ingredient is a source of active oxygen. A preferred source according to the present invention is hydrogen peroxide or sources thereof. As used herein a hydrogen peroxide source refers to any water-soluble sources of hydrogen peroxide. Suitable water-soluble sources of hydrogen peroxide for use herein include percarbonates, organic or inorganic peroxides and perborates.

Ideally, the pH of the first compartment is less than 7, ideally less than 5, preferably less than 4. Preferably the pH of the first compartment is greater than 1, greater than 2 or greater than 2.5.

Hydrogen peroxide or sources thereof provide from 0.1% to 15%, preferably from 0.5% to 10%, most preferably from 1% to 5% by weight of the total composition of active oxygen in the first compartment.

As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources according to the present invention increase the ability of the compositions to remove oxidisable stains, to destroy malodourous molecules and to kill germs.

The concentration of available oxygen can be determined by methods known in the art, such as the iodimetric method, the permanganometric method and the cerimetric method. Said methods and the criteria for the choice of the appropriate method are described for example in “Hydrogen Peroxide”, W. C. Schumo, C. N. Satterfield and R. L. Wentworth, Reinhold Publishing Corporation, New York, 1955 and “Organic Peroxides”, Daniel Swern, Editor Wiley Int. Science, 1970.

Suitable organic and inorganic peroxides for use in the compositions according to the present invention include diacyl and dialkyl peroxides such as dibenzoyl peroxide, dilauroyl peroxide, dicumyl peroxide, persulphuric acid and mixtures thereof. The first compartment according to the present invention comprise from 0% to 15%, preferably from 0.005% to 10%, by weight of the total composition of said organic or inorganic peroxides.

pH

The pH of the first compartment is preferably less than 7, ideally less than 6.5, 6.0, 5.5, 5.0, 4.5, 4.0, 3.5 or 3.0. Ideally the pH is at least 1.0, 1.5, 2.0 or 2.5.

The pH of the second compartment is preferably greater than 7, ideally greater than 7.5, 8.0, 8.5, 9.0, 9.5 or 10.0. Ideally the pH is less than 13.0, 12.5, 12.0 or 11.5.

The pH of either the first or second compartment can be adjusted by the addition of a suitable acid or base.

### Alkalising Agent

As an essential element the compositions according to the present invention comprise an alkalising agent. The alkalising agent must be sufficient to raise the pH of the first and second compartment mixture to a pH of greater than 8, ideally greater than 9, 10, 11 or 12. Ideally the pH is raised up to 14, 13 or 12. Suitable alkalising agents are caustic alkalis such as sodium hydroxide, potassium hydroxide and/or lithium hydroxide and/or the alkali metal oxides such as sodium and/or potassium oxide. A preferred source of alkalinity is a caustic alkali, more preferably sodium hydroxide and/or potassium hydroxide.

Ideally, an alkaline buffering means is also present. An alkaline buffering means at a level of from 0.1% to 10% by weight of the second compartment. Preferably, the second compartment herein comprise from 0.2% to 8% by weight of the total composition of a pH buffering means or a mixture thereof, preferably from 0.3% to 5%, more preferably from 0.3% to 3% and most preferably from 0.3% to 2%.

By “alkaline buffering means”, it is meant herein any compound which when mixed with the first compartment makes the resulting solution able to resist an increase in hydrogen ion concentration.

Preferred alkaline buffering means for use herein comprise an acid having its pK (if only one) or at least one of its pKs in the range from 7.5 to 12.5, preferably from 8 to 10, and its conjugated base.

pK is defined according to the following equation:

pK=−log K

where K is the Dissocation Constant of the weak acid in water and corresponds to the following equation:

[A] [H]/[HA]=K

where HA is the acid and A is the conjugated base.

Preferably the alkaline buffering means herein consists of the weak acid as defined herein and its conjugate base at a weight ratio of the weak acid to its conjugate base of preferably 0.1:1 to 10:1, more preferably 0.2:1 to 5:1. Highly preferred ratio of the weak acid to its conjugate base is 1 since this is the best combination to achieve optimum buffering capacity.

Preferably a given pH buffering means herein will be used to buffer compositions having a pH between pH=pK−1 and pH=pK+1 of each of its pK.

### Effervescence

In one preferred embodiment of the invention an effervescent effect is achieved upon mixing the first and second compartments. The effervescent agent containing component preferably comprises a base, preferably present at a level of from about 1% to about 10%, more preferably from about 2% to about 5% by weight of the compositions of the present invention. Preferably the effervescent agent is in the second compartment.

Suitable bases for use in the effervescent agent-containing component are selected from carbonates, bicarbonates, sesquicarbonates and mixtures thereof. Preferably, the base is selected from the group consisting of sodium carbonate, potassium carbonate, lithium carbonate, magnesium carbonate, calcium carbonate, ammonium carbonate, mono-, di-, tri-or tetra-alkyl or aryl, substituted or unsubstituted, ammonium carbonate, sodium bicarbonate, potassium bicarbonate, lithium bicarbonate, magnesium bi-carbonate, calcium bicarbonate, ammonium bicarbonate, mono-, di-, tri-or tetra-alkyl or aryl, substituted or unsubstituted, ammonium bicarbonate and mixtures thereof.

The most preferred bases are selected from the group consisting of sodium bicarbonate, monoethanol-ammonium bi-carbonate and mixtures thereof.

In another preferred embodiment, the effervescent agent preferably comprises a peroxide reducing enzyme that is held within the second compartment [and the first compartment containing hydrogen peroxide], such as peroxidase, laccase, dioxygenase and/or catalase enzyme, preferably catalase enzyme, preferably present at a level of from about 0.001% to about 10%, more preferably, from about 0.01% to about 5%, even more preferably from about 0.1% to about 1%, most preferably from about 0.1% to about 0.3% by weight of the compositions of the present invention. Catalase enzyme is commercially available from Biozyme Laboratories under the trade name Cat-1A, which is a bovine liver derived catalyse enzyme; from Genencor International under the trade name Oxy-Gone 400, which is a bacterial derived catalyse enzyme; and from Novo Nordisk under the trade name Terminox Ultra 50L.

### Quick Breaking Foam

The effervescence system linked with the presence of surfactant is likely to produce foam upon mixing the first compartment with the second compartment. However, it is not always desirable that the foam is one that is stable since this may mean that the foam is difficult to rinse away or obscures from the user the cleaning effect of the compositions.

Therefore, as a further feature of the invention the surfactant is selected from those that are capable of producing breaking foams. Preferably the foam breaks within 5 minutes of generation after application to the surface, ideally less than 5, 4, 3, 2, or 1 minute. Preferably the foam does not break for at least 10, 20 or 30 seconds or 1, 2 or 3 minutes. By the use of the term “break or breaks” we mean that at least 50% of the volume of foam generated by the mixing of the first compartment and (b) has disappeared without any form of physical or chemical intervention.

Preferred surfactants to produce capable of performing a break are:

### Anionic Surfactant

Preferred anionic surfactants capable of producing a breaking foam are ethoxylated alkyl sulfates of the formula:

RO(C₂H₄O)ₙSO₃⁻M⁺

wherein R is a C₈₋₂₀ alkyl group, preferably C₁₀₋₁₈ such as a C₁₂₋₁₆, n is at least 4, for example from 4 to 20, preferably 4 to 9, especially 4 to 6, and M is a salt-forming cation such as lithium, sodium, potassium, ammonium, alkylammonium or alkanolammonium.

### Nonionic Surfactants

Preferred nonionic surfactants capable of producing a breaking foam are fatty alcohol ethoxylates, especially those of formula:

R(C₂H₄O)ₙOH

wherein R is a straight or branched C₉₋₁₆ alkyl group, preferably a C₉₋₁₅, for example C₁₀₋₁₄, alkyl group and n is at least 4, for example from 4 to 16, preferably 4 to 12, more preferably 4 to 10.

Preferably the HLB value is greater than 9, ideally greater than 10.

The ethoxylated fatty alcohol nonionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company.

An additional or alternative group of preferred nonionic surfactants are the polyoxyalkylated non-ionics of formula:

R¹O[CH₂CH (R³)O]ₓ[CH₂]ₖCH(OH)[CH₂]ⱼOR²

wherein R¹ and R² represent linear or branched chain, saturated or unsaturated, aliphatic or aromatic hydrocarbon groups with 1-30 carbon atoms (presently 1 to 10) or one of R¹ and R² may be a hydrogen, R³ represents a hydrogen atom or a methyl group, x is a value between 2 and 30 and, k and j are values between 1 and 12, preferably between 1 and 5. R¹ and R² are preferably linear or branched chain, saturated or unsaturated, aliphatic or aromatic hydrocarbon groups with 6-22 carbon atoms, where group with 8 to 18 carbon atoms are particularly preferred. Particularly preferred values for x are comprised between 2 and 20, preferably between 4 and 15.

When x=2 or 3, the group R³ could be chosen to build ethylene oxide (R³=H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 2 or 3 for x is only an example and bigger values can be chosen whereby a higher number of variations of (EO) or (PO) units would arise.

Alternatively when x=2 or 3, the group R³ could be chosen to build ethylene oxide (R³=H) or propylene oxide (R³=methyl) units which can be used in every single order for instance (EO)(EO)(EO), (PO)(PO)(PO), (PO)(EO)(PO), (EO)(PO)(EO), (PO)(PO) and (EO)(EO). The value 2 or 3 for x is only an example and bigger values can be chosen whereby a higher number of variations of (EO) or (PO) units would arise.

Particularly preferred polyoxyalkylated alcohols of the above formula are those where k=1 and j=1 originating molecules of simplified formula:

R¹O[CH₂CH(R³)O]ₓCH₂CH(OH)CH₂OR². A suitable example is Biodac 232, available from Condea or Berol 185 from Akzo Nobel.

### Enzyme

Where present said enzymes are preferably selected from cellulases, hemicellulases, peroxidases, proteases, gluco-amylases, amylases, xylanases, phospholipases, esterases, cutinases, pectinases, keratanases, reductases, oxidases, phenoloxidases, lipoxygenases, ligninases, pullunases, tannases, pentosanases, malaneases, β-glucanases, arabinosidases, hyaluronidase, chondroitinase, laccase or mixtures thereof.

Preferred enzymes include protease, amylase, peroxidases, cutinase and/or cellulase.

The cellulases usable in the present invention include either bacterial or fungal cellulase. Preferably, they will have a pH optimum of between 5 and 12 and an activity above 50 CEVU (Cellulose Viscosity Unit). Suitable cellulases are disclosed in U.S. Pat. No. 4,435,307, JP-A-61078384 and WO-A-96/02653 which disclose fungal cellulases produced respectively from Humicola insolens, Trichoderma, Thielavia and Sporotrichum. EP-A-739 982 describes cellulases isolated from novel Bacillus species. Suitable cellulases are also disclosed in GB-A-2.075.028; GB-A-2.095.275; DE-OS-2.247.832 and WO-A-95/26398.

If present, cellulases are normally incorporated in the detergent composition at levels from 0.0001% to 2% of active enzyme by weight of the detergent composition.

Peroxidase enzymes are used in combination with oxygen sources, e.g. percarbonate, perborate, persulfate, hydrogen peroxide, etc. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase and haloperoxidase such as chloro- and bromo-peroxidase. Peroxidase-containing detergent compositions are disclosed, for example, in WO-A-89/099813, WO-A-89/09813 and in EP-A-540784. Also suitable is the laccase enzyme.

If present, peroxidases are normally incorporated in the detergent composition at levels from 0.0001% to 2% of active enzyme by weight of the detergent composition.

Suitable proteases are the subtilisins which are obtained from particular strains of B. subtilis and B. licheniformis (subtilisin BPN and BPN′). One suitable protease is obtained from a strain of Bacillus, having maximum activity throughout the pH range of 8-12, developed and sold as ESPERASE™ by Novo Industries A/S of Denmark, hereinafter “Novo”. The preparation of this enzyme and analogous enzymes is described in GB-A-1,243,784 to Novo. Other suitable proteases include ALCALASE™, DURAZYM™ and SAVINASE™ from Novo and MAXATASE™, MAXACAL™, PROPERASE™ and MAXAPEM™ (protein engineered Maxacal) from Gist-Brocades. Proteolytic enzymes also encompass modified bacterial serine proteases, such as those described in EP-A-292623 (particularly pages 17, 24 and 98), and which is called herein “Protease B”, and in EP-A-199,404, which refers to a modified bacterial serine proteolytic enzyme which is called “Protease A” herein. Suitable is what is called herein “Protease C”, which is a variant of an alkaline serine protease from Bacillus in which lysine replaced arginine at position 27, tyrosine replaced valine at position 104, serine replaced asparagine at position 123, and alanine replaced threonine at position 274. Protease C is described in WO-A-91/06637. Genetically modified variants, particularly of Protease C, are also included herein.

High pH protease are preferred, such as from Bacillus sp. NCIMB 40338 described in WO-A-93/18140. Enzymatic detergents comprising protease, one or more other enzymes, and a reversible protease inhibitor are described in WO-A-92/03529. When desired, a protease having decreased adsorption and increased hydrolysis is available as described in WO-A-95/07791. A recombinant trypsin-like protease for detergents suitable herein is described in WO-A-94/25583. Other suitable proteases are described in EP-A-516,200.

The proteolytic enzymes are incorporated in either or both compositions at a level of from 0.0001% to 2%, preferably from 0.001% to 0.2%, more preferably from 0.005% to 0.1% pure enzyme by weight of the composition.

Amylases (α and/or β) can be included for removal of carbohydrate-based stains. WO-A-94/02597 describes cleaning compositions which incorporate mutant amylases. See also WO-A-95/10603. Other amylases known for use in cleaning compositions include both α- and β-amylases. α-Amylases are known in the art and include those disclosed in U.S. Pat. No. 5,003,257; EP-A-252,666; WO-A-/91/00353; FR-A-2,676,456; EP-A-285,123; EP-A-525,610; EP-A-368,341; and GB-A-1,296,839. Other suitable amylases are stability-enhanced amylases described in WO-A-94/18314 and WO-A-96/05295 and amylase variants having additional modification in the immediate parent available from Novo Nordisk A/S, disclosed in WO-A-95/10603. Also suitable are amylases described in EP-A-277,216, WO-A-95/26397 and WO-A-96/23873.

Examples of commercial α-amylases products are Purafect Ox Am™ from Genencor and Termamyl™, Ban™,Fungamyl™ and Duramyl™, Natalase™ all available from Novo Nordisk A/S Denmark. WO-A-95/26397 describes other suitable amylases: α-amylases characterised by having a specific activity at least 25% higher than the specific activity of Termamyl™ at a temperature range of 25 DEG C. to 55 DEG C. and at a pH value in the range of 8 to 10, measured by the Phadebas™ α-amylase activity assay. Suitable are variants of the above enzymes, described in WO-A-96/23873. Other amylolytic enzymes with improved properties with respect to the activity level and the combination of thermostability and a higher activity level are described in WO-A-95/35382.

Preferred amylase enzymes include those described in WO-A-95/26397 and in co-pending application by Novo Nordisk PCT/DK96/00056.

The amylolytic enzymes are incorporated in either or both compositions at a level of from 0.0001% to 2%, preferably from 0.00018% to 0.06%, more preferably from 0.00024% to 0.048% pure enzyme by weight of the composition

As used herein, the terms “perhydrolase” refers to an enzyme that is characterized by perhydrolitic activity. The enzyme is selected from the group consisting of lipases, esterases, proteases, and/or mixtures thereof wherein the catalyst has perhydrolitic activity. The enzyme may be in the form of a whole microbial cell, permeabilized microbial cell(s), one or more cell components of a microbial cell extract, partially purified enzyme, or purified enzyme. The perhydrolase enzyme is preferably present in the range of 0.0001 to 10%, more preferably 0.001 to 1%.

### Surfactant

Preferably, the total levels of surfactant are at levels of 0.1 to 25% wt, ideally from 1 to 10% wt.

Ideally, sufficient surfactant is present in the first and second compartments such that upon mixture thereof the critical micelle concentration (CMC) is reached, i.e. the level above which formation of micelles occurs [typically measured by a change in physical properties, i.e. turbidity or conductivity].

Preferably non-ionic surfactants are used. Examples of non-ionic surfactants are fatty acid alkoxylates, such as fatty acid ethoxylates, especially those of formula:

R(C₂H₄O)ₙOH

wherein R is a straight or branched C₉₋₁₆ alkyl group, preferably a C₉₋₁₅, for example C₁₀₋₁₄, alkyl group and n is at least 1, for example from 1 to 16, preferably 2 to 12, more preferably 3 to 10.

The alkoxylated fatty alcohol non-ionic surfactant will frequently have a hydrophilic-lipophilic balance (HLB) which ranges from 3 to 17, more preferably from 6 to 15, most preferably from 7 to 13.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂₋₁₃ alcohol having about 9 moles of ethylene oxide; and Neodol 91-10, an ethoxylated C₉₋₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉₋₁₁ fatty alcohol with an average of 5 moles ethylene oxide and Dobanol 25-7 is an ethoxylated C₁₂₋₁₅ fatty alcohol with an average of 7 moles of ethylene oxide per mole of fatty alcohol.

Other examples of suitable ethoxylated alcohol non-ionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁₋₁₅ linear secondary alkanol with 7 moles of ethylene oxide and Tergitol 15-S-9 is the same but with 9 moles of ethylene oxide.

Other suitable alcohol ethoxylated non-ionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further non-ionic surfactants are, for example, C₁₀₋₁₈ alkyl polyglycosides, such s C₁₂₋₁₆ alkyl polyglycosides, especially the polyglucosides. These are especially useful when high foaming compositions are desired. Further surfactants are polyhydroxy fatty acid amides, such as C₁₀₋₁₈ N-(3-methoxypropyl) glycamides and ethylene oxide-propylene oxide block polymers of the Pluronic type.

The surfactant can also be an anionic surfactant. Such anionic surface active agents are frequently provided in a salt form, such as alkali metal salts, ammonium salts, amine salts, aminoalcohol salts or magnesium salts. Contemplated as useful are one or more sulfate or sulfonate compounds including: alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Particularly preferred are alkyl sulfate anionic surfactants. Most preferred are the non-ethoxylated C₁₂₋₁₅ primary and secondary alkyl sulfates, especially sodium lauryl sulfate.

In a further feature of the invention a surfactant is chosen to be present in either the first or second or both the first and second compartments that is capable of forming a stable foam. Such systems are described in EP0745665.

### Polymer

Suitable polymers are those that are water-soluble and include polycarboxylate polymer (such as those that can be purchased by Rohm and Haas under the Acusol 445N name) and polycarboxylic acid copolymers (such as can be purchased under the Sokalan CP9 name by BASF).

Compositions suitable for carrying out the invention may be provided as separate components suitable for mixing by the consumer. Where the compositions are suitable for mixing they may be mixed either directly at the surface or remote from the surface before application.

The first compartment preferably comprises hydrogen peroxide.

In accordance with the invention the first and second compartments may be mixed in any suitable proportions, depending upon their initial concentrations, suitably such that the finally applied mixture comprises 0.01-30%, by weight of hydrogen peroxide. Preferably, the ratio of the first compartment to the second compartment is from 10:1 to 1:10, most preferably from 2:1 to 1:2.

When the first compartment and (b) are mixed it is preferred that the pH of the mixture is greater than 7, ideally greater than 8, 9, 10, 11 or 12.

It is preferred that the first and second compartments are mixed no more than 10 minutes before application to the surface requiring stain removal.

It is most preferred that the first and second compartments are mixed at the surface requiring stain removal, so that the improved stain removal effect may occur immediately.

In this aspect the first compartment may be applied to the surface followed by the second compartment or vice versa. Alternatively (and preferably) the first and second compartments are applied to the surface substantially simultaneously within 30 seconds.

According to a preferred embodiment of the presentation invention, the concentration of hydrogen peroxide in the composition immediately after mixing is from 0.01 to 10% w/w. This would mean for example in a 1:1 mix of the first compartment and (b) that the first compartment prior to the mixing would contain from 0.02 to 20% w/w of hydrogen peroxide.

Where the first compartment comprises hydrogen peroxide it is most preferred that the concentration of hydrogen peroxide in the mixture immediately after mixing should be from 1.5 to 5% w/w. For example, if a 1:1 mixture of the first and second compartments is to be mixed, then the first compartment should comprise from 3 to 10% w/w hydrogen peroxide.

The concentration of the enzyme in the second compartment will be less than 1% wt.

The present invention alleviates the need to use further stabilising components for the hydrogen peroxide or enzyme when preparing commercial products.

The components suitable for use may further include any other conventional additives known to the art. Examples of these include fragrances, dyes, sequesterants, chelating agents, germicides, preservatives, corrosion inhibitors or antioxidants.

The above auxiliary components may be included in the compositions suitable for use in the process of the present invention at concentrations of from 0.01% w/w to 10% w/w. These auxiliary ingredients may be included in either the first compartment, or the second compartment or both if appropriate.

The present invention may use any appropriate containers known to the art. For example, the two compartments may comprise two-compartment packs suitable for sequential or simultaneous dispensing.

1. A multi-compartment dispenser comprising a first compartment containing an aqueous composition comprising a source of active oxygen and having a pH of greater than 0 but less than 7 and a perhydrolase enzyme;
a second compartment containing an aqueous composition comprising an ester; and
dispensing means adapted to dispense the contents (or part thereof) of the compartments on to a surface either sequentially or simultaneously to form a mixture thereof.

2. A dispenser according to claim 1, wherein the ester is present in an amount of 0.01 to 50 wt %.

3. A dispenser according to claim 1, wherein the ester is selected from the group comprising: methyl lactate, ethyl lactate, methyl glycolate, ethyl glycolate, methyl methoxyacetate, ethyl methoxyacetate, methyl 3-hydroxybutyrate, ethyl 3-hydroxybutyrate, ethyl methoxyacetate, ethylene glycol diacetate, propylene glycol diacetate, butyl acetate, isoamyl acetate, hexyl acetate, octyl acetate, linalyl acetate, citronellyl acetate, dodecyl acetate, neodol 233 acetate, neodol 236.5 acetate, neodol 239 acetate, ethyl propionate, butyl propionate, hexyl propionate, citronellyl propionate, ethyl butyrate, ethyl isobutyrate, ethyl 2-methylbutyrate, ethyl isovalerate, tributyrin, tricaproin, tricaprylin, dimethyl malonate, diethyl maleate, monoacetin, diacetin, triacetin, monobutyrin, dibutyrin, tributyrin, glyceryl monooctanoate, glyceryl dioctanoate, glyceryl trioctanoate, caproic acid ester, caprylic acid ester, nonanoic acid ester, decanoic acid ester, dodecanoic acid ester, myristic acid ester, palmitic acid ester, stearic acid ester, oleic acid ester and mixtures thereof.

4. A dispenser according to claim 1, wherein the hydrogen peroxide or sources thereof provide from 0.1% to 15% by weight of the total composition of active oxygen in the first compartment.

5. A dispenser according claim 1, wherein the perhydrolase enzyme is present in the range of 0.0001 to 10%.

6. A process for cleaning, comprising the step of:
dispensing at least a part of the contents of of a dispenser according to claim 1.

7. A process according to claim 6, wherein the process is a fabric cleaning process.

8. A dispenser according to claim 2, wherein the ester is present in an amount of 5-10 wt %.

9. A dispenser according to claim 4, wherein the hydrogen peroxide or sources thereof provide from 0.5% to 10% by weight of the total composition of active oxygen in the first compartment.

11. A dispenser according to claim 9, wherein the hydrogen peroxide or sources thereof provide from 1% to 5% by weight of the total composition of active oxygen in the first compartment.

12. A dispenser according to claim 2, wherein the hydrogen peroxide or sources thereof provide from 0.1% to 15% by weight of the total composition of active oxygen in the first compartment.

13. A dispenser according to claim 3, wherein the hydrogen peroxide or sources thereof provide from 0.1% to 15% by weight of the total composition of active oxygen in the first compartment.

14. A dispenser according to claim 2, wherein the perhydrolase enzyme is present in the range of 0.0001 to 10%.

15. A dispenser according to claim 14, wherein the perhydrolase enzyme is present in the range of 0.001 to 1%.

16. A dispenser according to claim 3, wherein the perhydrolase enzyme is present in the range of 0.0001 to 10%.

17. A dispenser according to claim 16, wherein the perhydrolase enzyme is present in the range of 0.001 to 1%.

18. A dispenser according to claim 4, wherein the perhydrolase enzyme is present in the range of 0.0001 to 10%.

19. A dispenser according to claim 18, wherein the perhydrolase enzyme is present in the range of 0.001 to 1%.
